(19) United States
(12) Patent Application Publication
(10) Pub. No.: US 2013/0187848 A1
(43) Pub. Date: Jul. 25, 2013

(54) ELECTRONIC DEVICE, CONTROL METHOD, AND COMPUTER PRODUCT

(71) Applicant: FUJITSU MOBILE COMMUNICATIONS LIMITED, Kawasaki-shi (JP)

(72) Inventor: Yasuhiko Abe, Niiza (JP)

(73) Assignee: FUJITSU MOBILE COMMUNICATIONS LIMITED, Kawasaki-shi (JP)

(21) Appl. No.: 13/689,503

(22) Filed: Nov. 29, 2012

(30) Foreign Application Priority Data
Jan. 20, 2012 (JP) 2012-009640

(51) Int. Cl. G06F 3/01

(52) U.S. Cl. CPC G06F 3/01
USPC 345/156

(57) ABSTRACT

An electronic device includes an input control processing unit that culls first input data by generating second input data from the first input data; an output control processing unit that culls output data; and a congestion control unit that instructs the input control processing unit to increase a quantity of the first input data to be culled, when delay in output relative to input is increasing, and instructs the output control processing unit to increase a quantity of the output data to be culled when the delay in output relative to input continues to increase despite the increase in the quantity of the first input data to be culled.

### CROSS REFERENCE TO RELATED APPLICATIONS

This application is based upon and claims the benefit of priority of the prior Japanese Patent Application No. 2012-009640, filed on Jan. 20, 2012, the entire contents of which are incorporated herein by reference.

### FIELD

The embodiments discussed herein are related to an electronic device and a control method.

### BACKGROUND

A conventional method is known, according to which when a further scroll operation is detected after the start of scroll display, the image displayed is changed to a given image according to the scroll and the scroll is allowed to be further performed to display a final target image (see, e.g., Japanese Laid-Open Patent Publication No. 2008-15592). Another method is also known, according which a process that corresponds to the previous input operation and is under execution consequent to a delay is terminated and a process corresponding to a subsequent input operation is preferentially executed (see, e.g., Japanese Laid-Open Patent Publication No. H8-202523).

According to the conventional techniques, a delay in display relative to input is seemingly canceled out by culling images to be displayed during a process of scroll display, or a delay in output relative to the latest input is canceled out by culling a process under execution or a process to be executed and executing a process corresponding the latest input. Consequently, a problem arises in that the continuity of display and processing is lost before and after culling of input and output.

### SUMMARY

According to an aspect of an embodiment, an electronic device includes an input control processing unit that culls first input data by generating second input data from the first input data; an output control processing unit that culls output data; and a congestion control unit that instructs the input control processing unit to increase a quantity of the first input data to be culled, when delay in output relative to input is increasing, and instructs the output control processing unit to increase a quantity of the output data to be culled when the delay in output relative to input continues to increase despite the increase in the quantity of the first input data to be culled.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of components that control input and output with respect to an electronic device according to a first embodiment;

FIG. 2 is a flowchart of a control method according to the first embodiment;

FIG. 3 is a block diagram of a hardware configuration of an electronic device according to a second embodiment;

FIG. 4 is a block diagram of a functional configuration of the electronic device according to the second embodiment;

FIG. 5 is a graph of a result of simulation of a culling process by a moving average method by the electronic device of the second embodiment;

FIG. 6 is another graph of a result of simulation of the culling process by the moving average method by the electronic device of the second embodiment;

FIG. 7 is a display example of a result of simulation of the culling process by the moving average method in a case where a straight line is drawn on the electronic device of the second embodiment;

FIG. 8 is a graph of a result of simulation of a smoothing culling process in a case where a straight line is drawn on the electronic device of the second embodiment;

FIG. 9 is a display example of a result of simulation of the smoothing culling process in a case where a straight line is drawn on the electronic device of the second embodiment;

FIG. 10 is a table of one example of display data in the display example of FIG. 9;

FIG. 11A is a flowchart of a display process by the electronic device of the second embodiment;

FIG. 11B is a flowchart depicting steps subsequent to the steps in FIG. 11A;

FIG. 12 is a flowchart of an output process by the electronic device of the second embodiment;

FIG. 13 is a flowchart of an input process by the electronic device of the second embodiment; and

FIG. 14 is a flowchart of a congestion control process by the electronic device of the second embodiment.

### DESCRIPTION OF EMBODIMENTS

Preferred embodiments will be described with reference to the accompanying drawings. In each of the embodiments, identical components are given the same reference numerals and redundant description thereof is omitted.

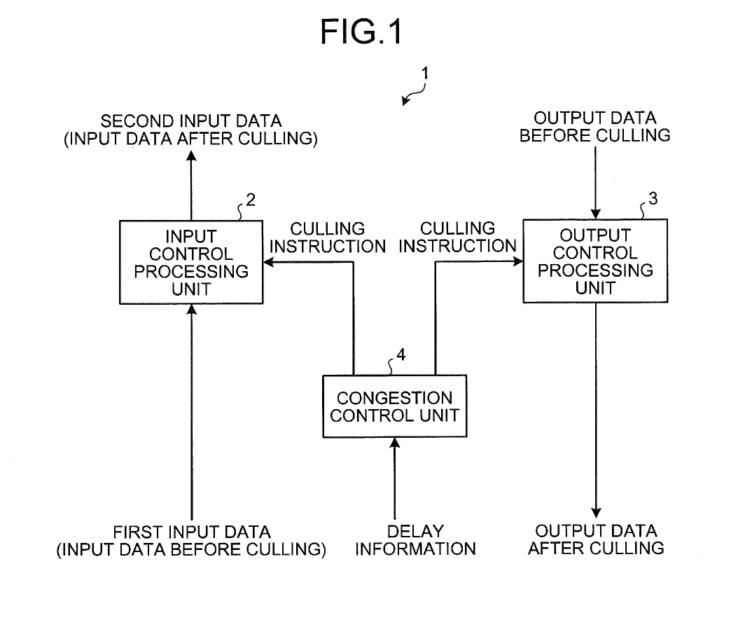

FIG. 1 is a block diagram of components that control input and output with respect to an electronic device according to a first embodiment. As depicted in FIG. 1, an electronic device 1 includes an input control processing unit 2, an output control processing unit 3, and a congestion control unit 4.

The input control processing unit 2 culls first input data by generating second input data from the first input data. The first input data is acquired via, for example, an input device (not depicted), such as a touch panel, key, cursor key, microphone, and camera.

The output control processing unit 3 culls output data. The output data is sent to, for example, an output device, such as a display panel and speaker.

Based on information concerning a delay in output relative to input, the congestion control unit 4 instructs the input control processing unit 2 to increase the quantity of first input data that are to be culled, when the delay is increasing. The congestion control unit 4 instructs the output control processing unit 3 to increase the quantity of output data that are to be culled, when the delay in output relative to input continues to increase despite an increase in the quantity of first input data to be culled.

The congestion control unit 4 may acquire information concerning a delay in output relative to input, for example, from the input control processing unit 2. For example, when first input data sent from an input device accumulates without being processed, the input control processing unit 2 may report the delay in output relative to input, to the congestion control unit 4.

The congestion control unit 4 may acquire information concerning a delay in output relative to input, for example, from the output control processing unit 3. For example, when output requests to an output device are not sent to the output device and accumulate, the output control processing unit 3 may report a delay in output relative to input, to the congestion control unit 4.

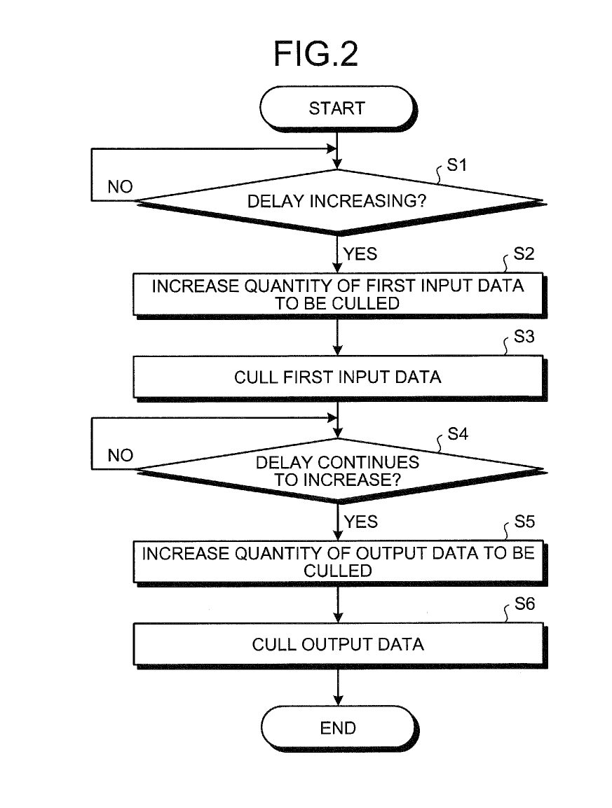

FIG. 2 is a flowchart of a control method according to the first embodiment. As depicted in FIG. 2, when the electronic device 1 starts a process of controlling input/output and a delay in output relative to input increases (step S1: YES), the congestion control unit 4 instructs the input control processing unit 2 to increase the quantity of first input data that are to be culled (step S2).

The congestion control unit 4 does not issue an instruction to increase the quantity of first input data to be culled unless a delay in output relative to input increases (step S1: NO). Based on the quantity of first input data to be culled specified in the instruction from the congestion control unit 4, the input control processing unit 2 generates second input data from the first input data and thereby, culls the first input data (step S3).

If the delay in output relative to input continues to increase despite the increase in the quantity of first input data to be culled (step S4: YES), the congestion control unit 4 instructs the output control processing unit 3 to increase the quantity of output data to be culled (step S5). If the delay does not continue to increase (step S4: NO), the congestion control unit 4 does not issue an instruction to increase the quantity of output data to be culled.

Based on the quantity of output data to be culled specified in the instruction from the congestion control unit 4, the output control processing unit 3 culls output data (step S6). The electronic device 1 then ends the series of steps for processing input/output.

According to the first embodiment, when a delay in output relative to input arises, the input-side culls input data first according to the extent of delay. If a further delay in output still arises, the output-side then culls output data according to the extent of delay, thereby preventing the loss of the continuity in display and processing, before and after culling of input and output.

A second embodiment relates to an example in which the electronic device of the first embodiment is applied to a portable terminal. One example of a portable terminal is a communication terminal, such as a cellular phone, smart phone, and tablet computer or notebook computer having a communication function. The electronic device of the first embodiment may also be applied to electronic equipment that processes input data to output data, such as a stand-alone computer not connected to a network. The second embodiment will be described by taking an example of a smart phone.

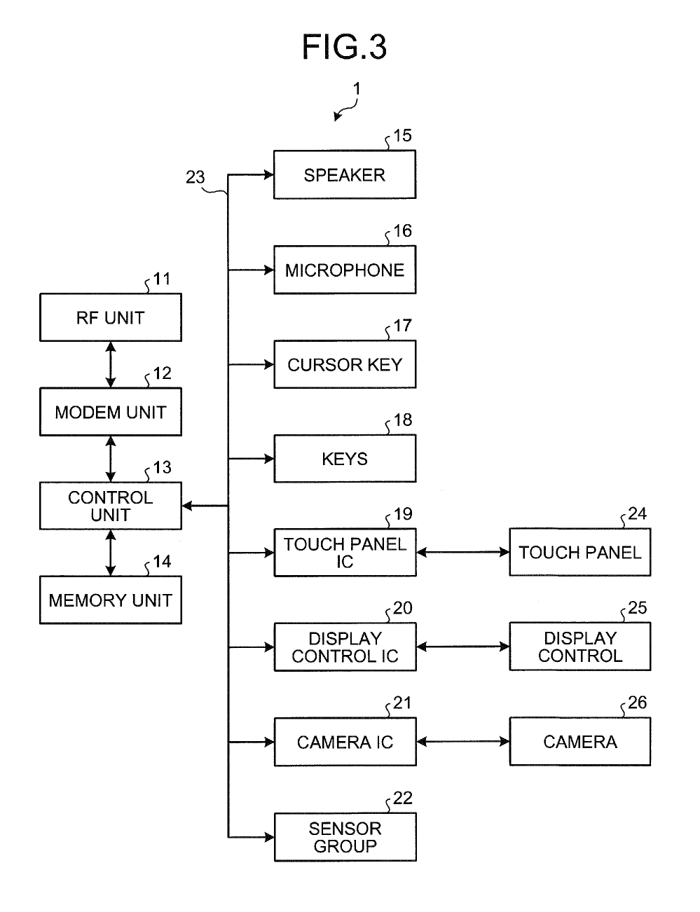

FIG. 3 is a block diagram of a hardware configuration of an electronic device according to the second embodiment. As depicted in FIG. 3, the electronic device 1 includes a radio frequency (RF) unit 11, a modem unit 12, a control unit 13, and a memory unit 14. The electronic device 1 also includes a speaker 15, a microphone 16, a cursor key 17, keys 18, a touch panel integrated circuit (IC) 19, a display control IC 20, a camera IC 21, and a sensor group 22. These component units 11 to 22 may be connected to a bus 23.

The RF unit 11 executes a transmission process on a signal output from the modem unit 12 to generate a high-frequency signal, and sends the high-frequency signal through an antenna (not depicted). The RF unit 11 further executes a reception process on a high-frequency signal coming in through the antenna (not depicted). The modem unit 12 modulates an output signal from the control unit 13 and demodulates the signal output from the RF unit 11.

The control unit 13 executes a program for realizing the input control processing unit 2, a display control processing unit, and the congestion control unit 4, which will be described later. The control unit 13 further executes various types of programs, such as an operation system (OS), application software, and a device driver that controls various input devices and output devices.

The memory unit 14 stores programs, such as the operation system, application software, control programs, device drivers, etc. These programs may be stored in, for example, a read-only memory (ROM) of the memory unit 14.

These program need not be stored in the memory unit 14. Configuration may be such that the electronic device 1 reads these programs from a memory medium, such as compact disk read-only memory (CD-ROM), to execute the programs. These programs may be stored in a computer (or server), etc., connected to the electronic device 1 via a public line, the Internet, a local area network (LAN), a wide area network (WAN), etc. In such a case, the electronic device 1 reads a program from the computer (or server), etc. and executes the read program.

The memory unit 14 is used as a work area of the control unit 13. The control unit 13 may use, for example, a random access memory (RAM) of the memory unit 14, as a work area. The memory unit 14 has a buffer area in which display data made by application software is stored.

The speaker 15 outputs as audio, results obtained consequent to execution of various programs by the control unit 13 and communication contents. The microphone 16 receives audio input from a user. The cursor key 17 and the keys receive input consequent to the user manipulating the cursor key 17.

The touch panel IC 19 controls a touch panel 24 connected to the touch panel IC 19, and receives input from the touch panel 24. The display control IC 20 controls a display panel 25 connected to the display control IC 20. The display control IC 20 executes a process of displaying on the display panel 25, results obtained consequent to execution of various programs by the control unit 13.

The camera IC 21 controls a camera 26 connected to the camera IC 21, and receives input from the camera 26. The sensor group 22 includes various sensors, which are, for example, acceleration sensors, global positioning system (GPS) sensors, distance sensors, etc.

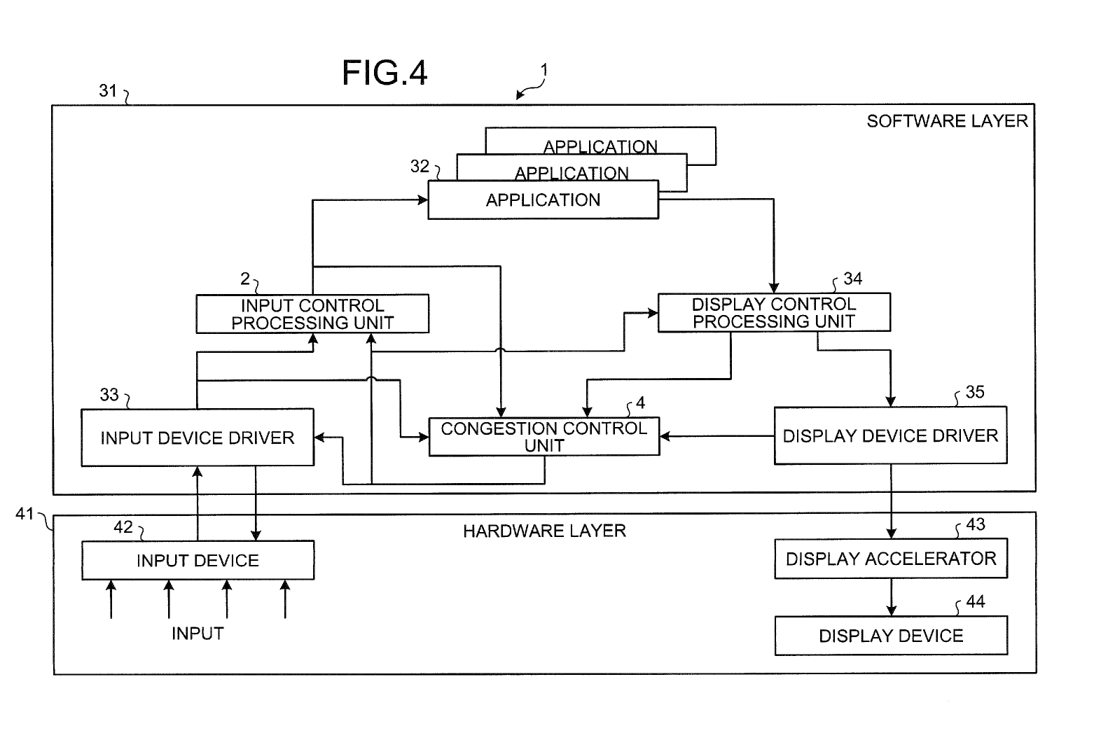

FIG. 4 is a block diagram of a functional configuration of the electronic device according to the second embodiment. As depicted in FIG. 4, the electronic device 1 includes a software layer 31 having application software 32, the input control processing unit 2, an input device driver 33, a display control processing unit 34 functioning as the output control processing unit, a display device driver 35, and the congestion control unit 4.

The software layer 31 is realized when the control unit 13 executes various programs, such as the operation system, application software, device driver, and control programs for controlling input/output. The electronic device 1 also includes a hardware layer 41 having an input device 42, a display accelerator 43, and a display device 44.

The input device 42 may be provided as, for example, the touch panel 24, the keys 18, the cursor key 17, the microphone 16, the camera 26, or the sensor group 22. The display device 44 may be provided as, for example, the display panel 25 or the speaker 15.

In the second embodiment, the touch panel 24 detects first input data when the user touches the touch panel 24 to perform input operation. A case will be described where based on the first input data or second input data generated by culling some of the first input data, the application software 32 generates display data and outputs the display data to the display panel 25 for display.

The input device driver 33 controls the input device 42, and receives first input data from the input device 42. The input device driver 33 determines whether the input control processing unit 2 has become incapable of processing an input event from the input device driver 33. When determining that the input control processing unit 2 has become incapable of processing the input event, the input device driver 33 reports the incapability of the control processing unit 2 to the congestion control unit 4.

The input control processing unit 2 receives first input data from the input device driver 33. The input control processing unit 2 detects that the first input data is not taken into the application software 32 but is accumulated in the memory unit 14. When detecting the occurrence of accumulation of the first input data, the input control processing unit 2 reports the accumulation of the first input data to the congestion control unit 4.

The input control processing unit 2 executes a culling process on the first input data by generating second input data from the first input data based on the quantity of first input data to be culled. The congestion control unit 4 may set the quantity of first input data to be culled according to the extent of delay in output relative to input. The input control processing unit 2 may generate the second input data by calculating, for example, a moving average of first input data of a quantity corresponding to the quantity of first input data to be culled.

One example of an equation for calculating a moving average is indicated as equation (1), where k (n) denotes the n-th first input data, n denotes an integer of 0 or greater one, K (n) denotes the n-th data after execution of the moving average method, that is, the n-th second input data, and m denotes a parameter for moving average calculation, the parameter may be, for example, a value given by adding 1 to the quantity of first input data to be culled. For example, if the quantity of first input data to be culled is represented as In_cnt, m is represented by equation (2).

K(n)=[k(n−(m−1))+k(n−(m−(m−2)))+ . . . +k(n−(m−(m−1)))+k(n)]/m (1)

m=In_cnt+1 (2)

The input control processing unit 2 outputs the first input data or second input data to the application software 32 according to the extent of delay in output relative to input. The application software 32 generates display data based on the first input data or second input data delivered from the input control processing unit 2.

The display control processing unit 34 receives a display request and display data from application software. The display control processing unit 34 detects that the display data is not sent from the display device driver 35 to the display accelerator 43 but is accumulated in the memory unit 14. When detecting the occurrence of accumulation of the display data, the display control processing unit 34 reports the display data accumulation to the congestion control unit 4.

When transfer of the display data from the display device driver 35 to the display accelerator 43 is completed, the display control processing unit 34 receives a transfer completion notice from the display device driver 35. If a new display request is sent from the application software 32 before the reception of the transfer completion notice, the display control processing unit 34 reports the new display request to the congestion control unit 4.

The display control processing unit 34 executes a culling process on display data accumulated in the buffer area, based on an instruction to increase/decrease the quantity of data to be culled, from the congestion control unit 4. The display control processing unit 34 may execute a smoothing culling process of culling the latest display data or the oldest display data from the display data accumulated in the buffer area, depending on, for example, a state of accumulation of the display data.

The display device driver 35 controls the display device 44, and delivers display data sent from the display control processing unit 34 to the display accelerator 43. The display device driver 35 detects that the display data is not sent from the display accelerator 43 to the display device 44 but is accumulated in the memory unit 14. When detecting the occurrence of accumulation of the display data, the display device driver 35 reports the display data accumulation to the congestion control unit 4.

The display accelerator 43 is a hardware accelerator, and processes display data delivered from the display device driver 35 to display the display data on the display device 44. The display device 44 performs display based on the processed data delivered from the display accelerator 43.

When receiving a report from the input device driver 33, the input control processing unit 2, the display control processing unit 34, or the display device driver 35, the congestion control unit 4 determines the extent of delay in output relative to input. When determining that the extent of delay in output relative to input is a congested state, the congestion control unit 4 requests the input control processing unit 2 to execute a culling process on first input data or requests the display control processing unit 34 to execute a culling process on display data.

The congestion control unit 4 may preferentially request the culling process on first input data and when the culling process on first input data is unlikely to remedy the congested state, may then request the culling process on display data. The congestion control unit 4 may first decrease the quantity of display data to be culled when the congested state is remedied to some extent and then may decrease the quantity of first input data to be culled when the congested state is further remedied.

When the input device 42 is configured to be capable of adjusting an interval of detection of first input data, the congestion control unit 4 may control the interval of detection of first input data by the input device 42. In this case, the congestion control unit 4 may control the input device 42 via the input device driver 33.

The result of comparison, through simulation, between a case of displaying data after execution of a culling process by the moving average method and a case of displaying data without executing the culling process by the moving average method will be described. Data input to the application software 32 in the case of not executing the culling process by the moving average method is first input data k (n). Data input in the case of executing the culling process by the moving average method is second input data K (n) calculated from the equation (1) based on the first input data k (n). For example, the value of m of the equation (2) is set to 2.

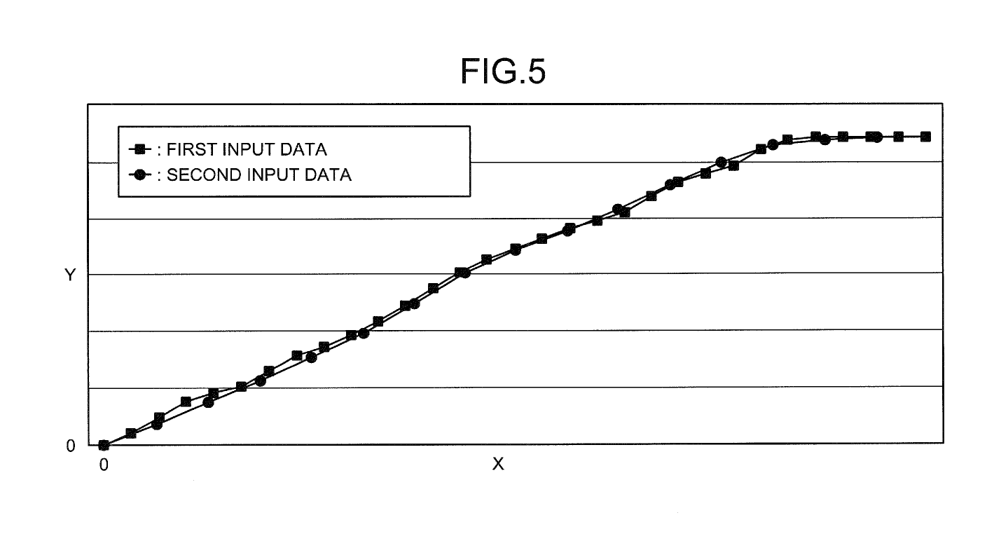

A case is assumed where when a finger kept in contact with the touch panel 24 is moved linearly, the extent of delay in output relative to input results in a congested state. With the congested state taken into consideration, a value given by adding a deviation factor of [±0.5×random number] to K (n) obtained from the equation (1) is determined to be second input data. A simulation result is depicted in FIG. 5.

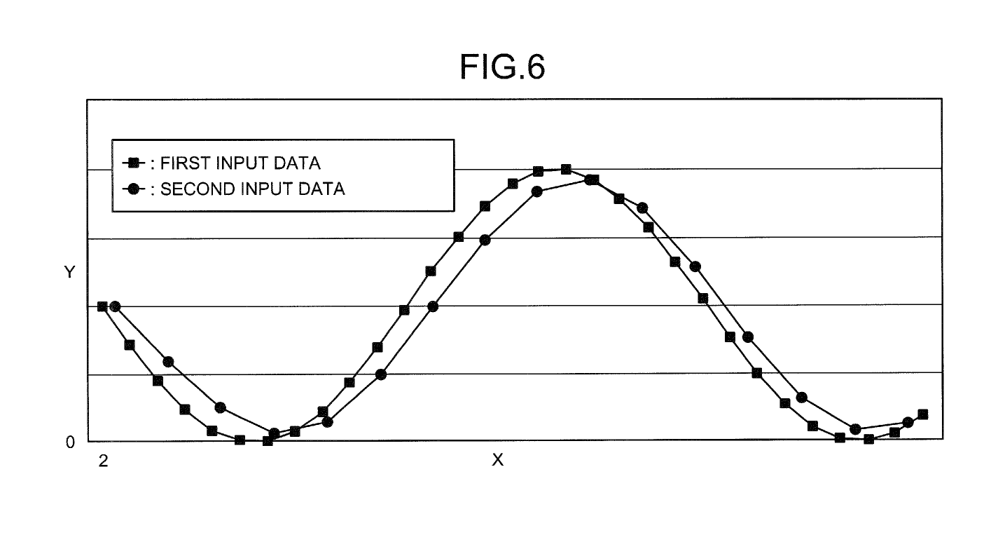

FIG. 5 is a graph of the result of simulation of a culling process by the moving average method by the electronic device of the second embodiment, in a case of linear movement. In FIG. 5, the horizontal axis represents a horizontal position X on the display panel 25 and the vertical axis represents a vertical position Y on the display panel 25 (which is the same in FIG. 6). As depicted in FIG. 5, second input data represented by the plotted curve is substantially the same as first input data represented by the plotted ▪ curve.

A case is assumed where when a finger kept in contact with the touch panel 24 is moved curvedly, the extent of delay in output relative to input results in a congested state. A case of circular movement will be described as an example of curved movement. With the congested state taken into consideration, a value given by adding a deviation factor of [±0.5×random number] to K (n) obtained from the equation (1) is determined to be second input data. A simulation result is depicted in FIG. 6.

FIG. 6 is a graph of the result of simulation of a culling process by the moving average method by the electronic device of the second embodiment, in a case of curved movement. As depicted in FIG. 6, second input data represented by the plotted curve is shifted in the X direction from first input data represented by the plotted ▪ curve but is substantially identical in shape with the first input data.

The result of FIG. 5 demonstrates that culling input data by taking a moving average of the input data is effective for an operation of linearly moving a finger kept in contact with the touch panel 24. The result of FIG. 6 demonstrates that culling input data by taking a moving average of the input data is effective also for an operation of circularly moving a finger kept in contact with the touch panel 24.

When a combination of linear movement and circular movement is considered, it can be concluded that the process of culling input data by taking a moving average of the input data is effective for an operation of moving a finger kept in contact with the touch panel 24 along an arbitrary shape. It is concluded, therefore, that the apparent continuity of display by the display panel 25 is not lost when the process of culling input data by the moving average method is executed.

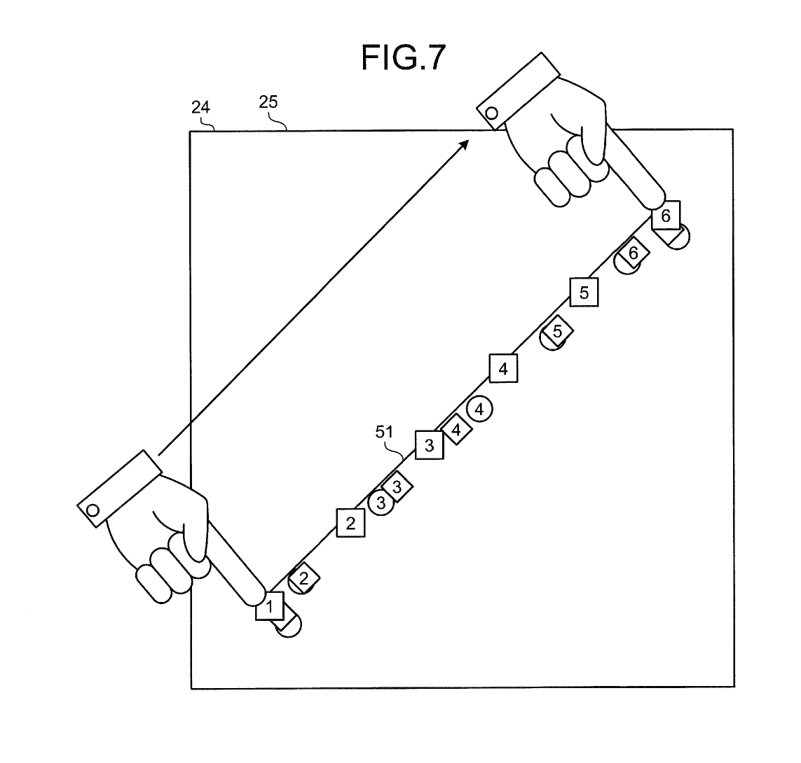

FIG. 7 is a display example of the result of simulation of a culling process by the moving average method in a case where a straight line is drawn on the electronic device of the second embodiment. In FIG. 7, a line 51 connecting a group of □ represents a trace of a finger touching the touch panel 24. It is assumed that along this trace, the touch panel 24 detects the contact by the finger as □ of 1, □ of 2, . . . , □ of 6 in ascending order.

◯ and ⋄ represent points that are displayed on the display panel 25 according to the contact (□) by the finger detected by the touch panel 24. ◯ represents points that are displayed when the culling process by the moving average is applied, while ⋄ represents points that are displayed when the culling process by the moving average is not applied. Numerals circumscribed in ◯ and ⋄ represent the order of display of ◯ and ⋄ on the display panel 25.

As depicted in FIG. 7, when the culling process by the moving average is applied, intervals of display of ◯ gradually expand after the start of move of the finger and then gradually shrink from the middle of the finger trace toward the end of movement of the finger. In other words, intervals of display of ◯ increase and decrease continuously. When the culling process by the moving average method is not applied, in contrast, intervals of display of ⋄ expand and shrink irregularly, i.e., intervals of display of ⋄ increase and decrease discontinuously. Executing the process of culling input data by the moving average method, therefore, causes the display panel 25 to perform continuous display.

The result of comparison through simulation between a case of executing a smoothing culling process on display data to display data and a case of executing a simple culling process, instead of the smoothing culling process, on display data to display data will be described. A delay level in a case where display data is not sent to the display device 44 but is accumulated in the buffer area of the memory unit 14, i.e., the level of display delay is expressed as Out_cnt.

When display data is not accumulated in the buffer area, i.e., when a display delay does not occur, the value of Out_cnt is 0. When display delay occurs, increasing the quantity of display data accumulated in the buffer area, the value of Out_cnt increases. Culling of the display data is started at a value given by subtracting 1 from the value of Out_cnt. This means that culling of the display data is not performed when the value of Out_cnt is 1, and is performed when the value of Out_cnt is 2 or more.

When a finger kept in contact with the touch panel 24 is moved linearly, the touch panel 24 detects the contact, for example, every 0.3 second. Display data corresponding to the contact detected by the touch panel 24 is displayed on the display panel 25, for example, every 0.5 second.

In the simple culling process, for example, the buffer area includes four display buffers each of which can, for example, store display data equivalent to one frame of display panel 25. When the four display buffers are filled with four frames of display data, the most recent display data is discarded among the display data stored in the four display buffers.

In the smoothing culling process, for example, when display data is stored in three display buffers, the oldest display data is discarded among the display data stored in the three display buffers. If a state of storage of display data in the three display buffers continues, the oldest display data and the most recent display data are discarded among the display data stored in the three display buffers.

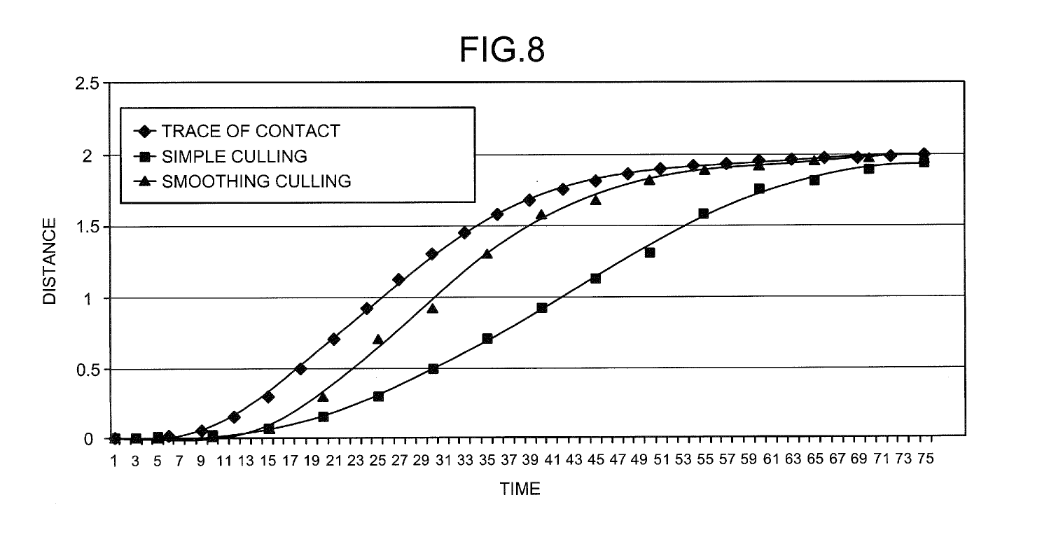

FIG. 8 is a graph of the result of simulation of the smoothing culling process in a case where a straight line is drawn on the electronic device of the second embodiment. FIG. 8 demonstrates that data display after execution of the smoothing culling process (represented by the plotted ▴) is closer to a trace of the contact by the finger (represented by the plotted ♦) than data display after execution of the simple culling process (represented by the plotted ▪).

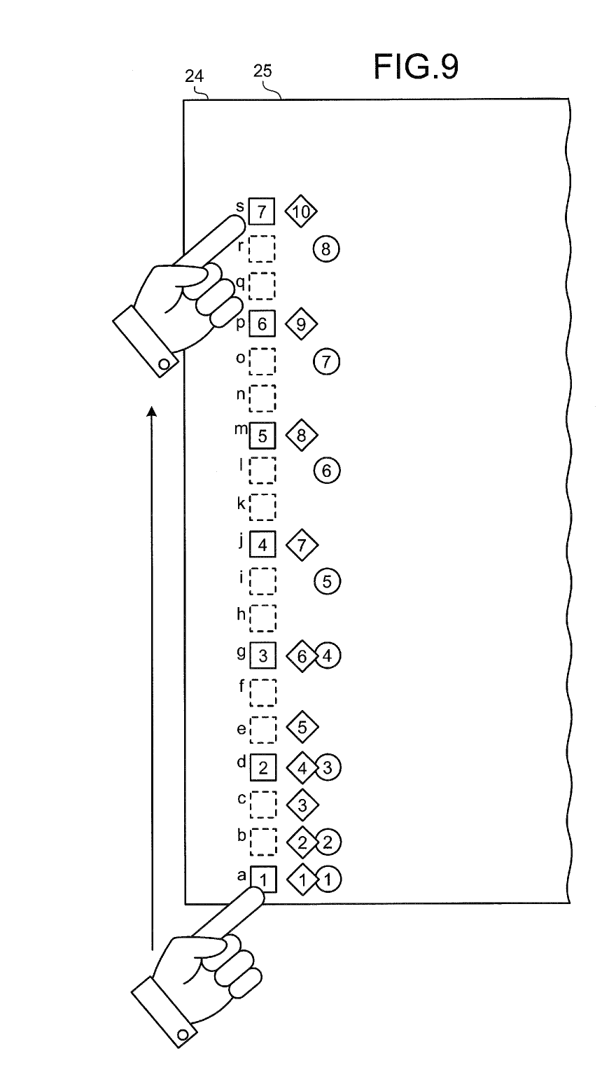

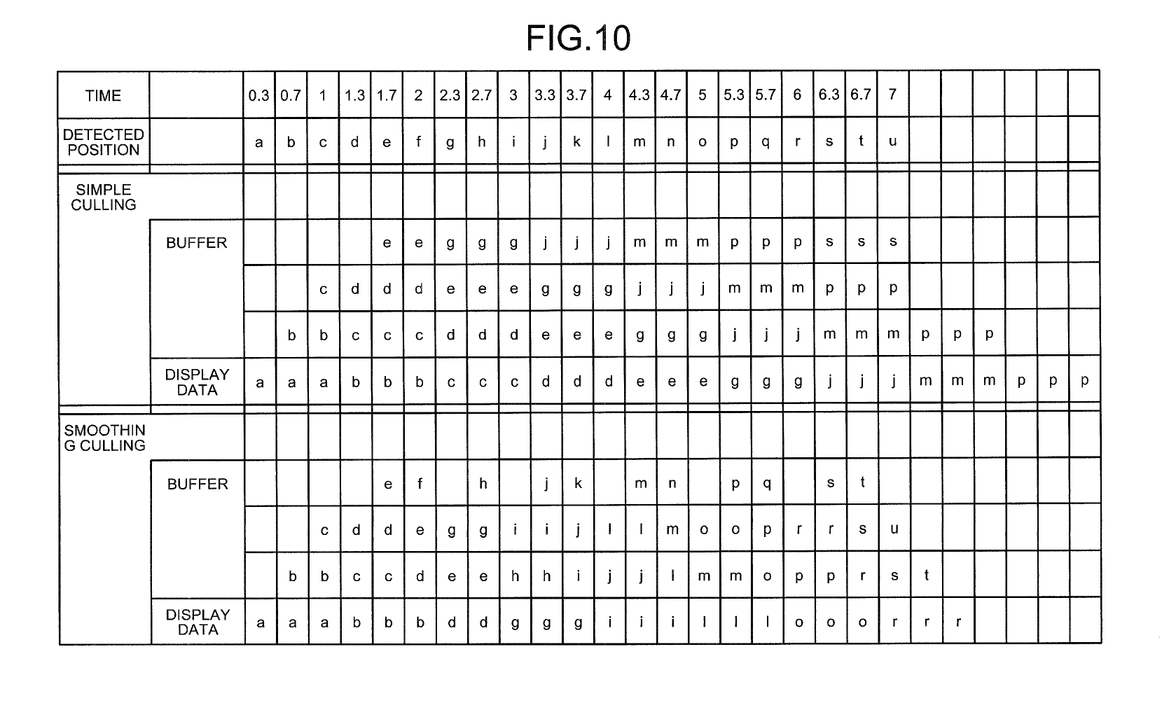

FIG. 9 is a display example of the result of simulation of the smoothing culling process in a case where a straight line is drawn on the electronic device of the second embodiment. FIG. 10 is a table of one example of display data in the display example of FIG. 9. When a finger kept in contact with the touch panel 24 is moved linearly, the touch panel 24 detects the contact by the finger, for example, every ⅓ second. In this case, the display panel 25 takes 1.0 second to display data.

In the simple culling process, for example, the buffer area includes three display buffers. When the three display buffers are filled with three frames of display data, the most recent display data is discarded among the display data stored in the three display buffers. Discard of display data in the smoothing culling process is performed in the manner as described above.

In FIG. 9, a group of □ to which a, b, c, . . . are appended represent positions at which the touch panel 24 detects the contact by the finger in a trace of the finger kept in contact with the touch panel 24 and moved linearly. a, b, c, . . . in FIG. 9 correspond to a, b, c, . . . in a row “detected position” in the table of FIG. 10. Figures described in □ represent elapsed times.

◯ and ⋄ represent points that are displayed on the display panel 25 according to the contact (□) by the finger detected by the touch panel 24. ◯ represents points that are displayed when the smoothing culling process is applied, while ⋄ represents points that are displayed when the simple culling process is applied. Numerals circumscribed in ◯ and ⋄ represent elapsed times.

As depicted in FIG. 9, for example, when the elapsed time is 6 seconds, the place at which the touch panel 24 detects the contact by the finger is “p”. When the smoothing culling process is applied, for example, the display position corresponding to the elapsed time of 6 seconds is “1”. When the simple culling process is applied, for example, the display position corresponding to the elapsed time of 6 seconds is “g”. When an elapsed time is 7 seconds, for example, the detected place of the contact is “s”, the display position in the case of application of the smoothing culling process is “o” and the same in the case of application of the simple culling process is “j”. These indicate that the case of applying the smoothing culling process brings display positions closer to detected places of the contact than the case of not applying the smoothing culling process.

In addition to the above variables In_cnt and Out_cnt, the following variables are set. Old_in_cnt is set as a value given by subtracting 1 from In_cnt, i.e., the old quantity of input data to be culled; and Old_out_cnt is set as a value given by subtracting 1 from Out_cnt, i.e., an old display delay level. The quantity of data to be culled in a display process is expressed as Out_Skip_cnt, and the quantity of display data accumulated in the display buffer is expressed as Buffer_cnt.

Driver_flg is also set as another variable. The value of Driver_flg may be 1 when an output request is made to the display device driver 35, the display accelerator 43, and the display device 44, and may be 0 when the display device driver 35, the display accelerator 43, and the display device 44 have completed respective processes. Each variable is reset before the display process is started after the power supply of the electronic device 1 is turned on.

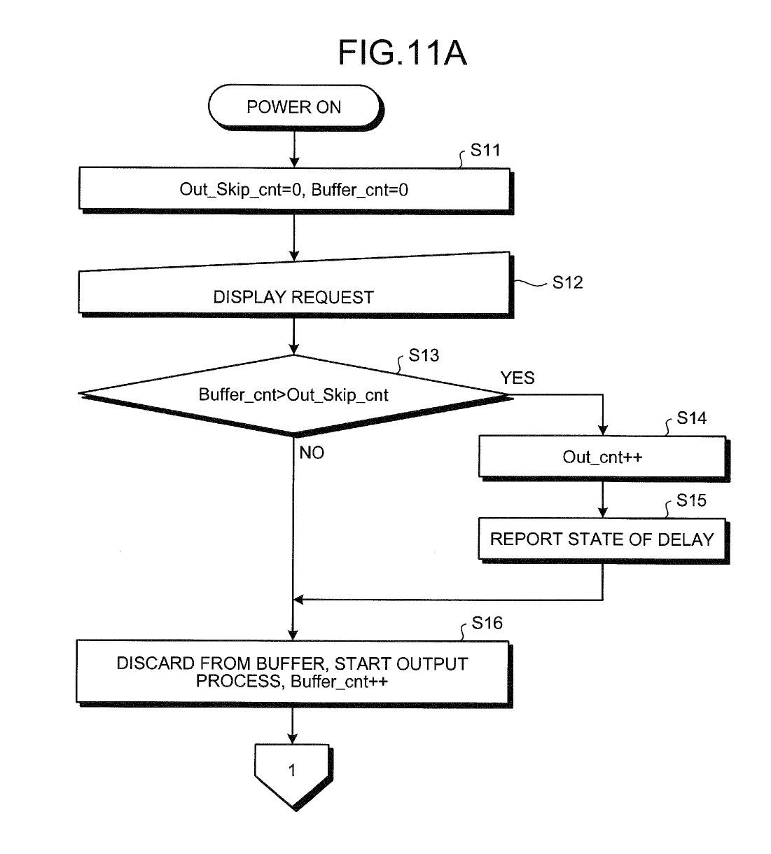

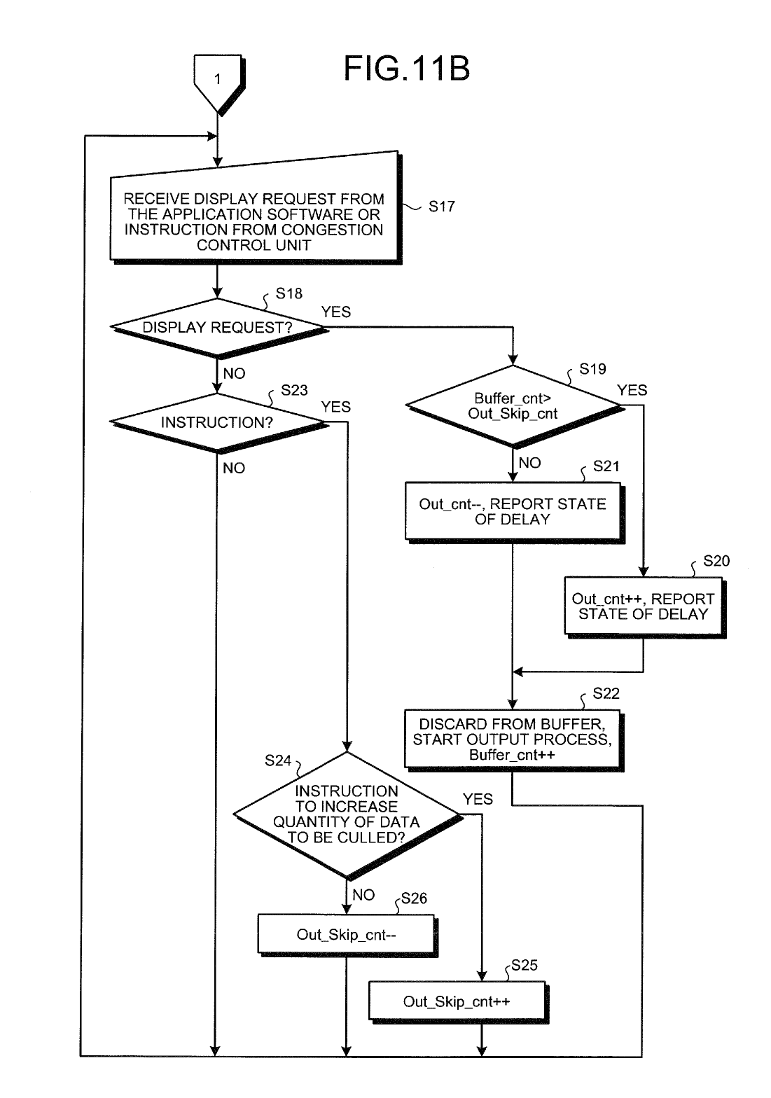

FIG. 11A is a flowchart of a display process by the electronic device of the second embodiment. FIG. 11B is a flowchart depicting steps subsequent to the steps in FIG. 11A. The display process is executed by the display control processing unit 34.

As depicted in FIG. 11A, the values of Out_Skip_cnt and Buffer_cnt are reset to 0 when the power supply of the electronic device 1 is turned on (step S11). When the display control processing unit 34 receives a display request from the application software 32 (step S12), if the value of Buffer_cnt is greater than the value of Out_Skip_cnt (step S13: YES), the value of Out_cnt is increased by 1 (step S14), which means the delay level at the display process is raised.

Subsequently, the display control processing unit 34 reports the state of delay in output relative to input, to the congestion control unit 4 (step S15). For example, the display control processing unit 34 may report the value of Out_cnt to the congestion control unit 4. The display control processing unit 34 then discards, from among display data accumulated in the display buffer, display data of a quantity is equivalent to the value of Out_Skip_cnt and starts an output process, which will be described later. Subsequently, the value of Buffer_cnt is increased by 1 (step S16).

When the display control processing unit 34 receives a display request from the application software 32 (step S12), if the value of Buffer_cnt is not greater than the value of Out_Skip_cnt (step S13: NO), steps S14 to S15 are omitted and the process flow proceeds to step S16. Immediately after turning on of the power supply of the electronic device 1, the value of Buffer_cnt is not greater than the value of Out_Skip_cnt (step S13: NO). In this case, therefore, the process flow proceeds directly to step S16.

Following step S16, as depicted in FIG. 11B, the display control processing unit 34 receives a display request from the application software 32 or an instruction from the congestion control unit 4 (step S17). When the display control processing unit 34 has received a display request from the application software 32 (step S18: YES) and the value of Buffer_cnt is greater than the value of Out_Skip_cnt (step S19: YES), the value of Out_cnt is increased by 1, which means the delay level at the display process is raised. The display control processing unit 34 then reports the state of delay in output relative to input, to the congestion control unit 4 (step S20).

If the display control processing unit 34 has received a display request from the application software 32 (step S18: YES) and the value of Buffer_cnt is not greater than the value of Out_Skip_cnt (step S19: NO), the value of Out_cnt is decreased by 1, which means the delay level at the display process is lowered. The display control processing unit 34 then reports the state of delay in output relative to input, to the congestion control unit 4 (step S21). At steps S20 and S21, for example, the display control processing unit 34 may report the value of Out_cnt to the congestion control unit 4.

Following steps S20 and S21, the display control processing unit 34 discards, from among display data accumulated in the display buffer, display data of a quantity equivalent to the value of Out_Skip_cnt and starts the output process, which will be described later. Subsequently, the value of Buffer_cnt is increased by 1 (step S22). The process flow then returns to step S17, from which steps S17 to S25 are repeated.

When the display control processing unit 34 has received not a display request from the application software 32 (step S18: NO) but an instruction from the congestion control unit 4 (step S23: YES) and the received instruction is the instruction to increase the quantity of data to be culled at the display process (step S24: YES), the value of Out_Skip_cnt is increased by 1 (step S25), which means the quantity of display data to be culled at the display process is increased. The procedure flow then returns to step S17, from which steps S17 to S25 are repeated.

When the instruction from the congestion control unit 4 is not the instruction to increase the quantity of data to be culled at the display process (step S24: NO), the value of Out_Skip_cnt is decreased by 1 (step S26), which means the quantity of display data to be culled at the display process is lowered. The process flow then returns to step S17, from which steps S17 to S25 are repeated. When the display control processing unit 34 has received neither a display request from the application software 32 (step S18: NO) nor an instruction from the congestion control unit 4 (step S23: NO), the process flow then returns to step S17, from which steps S17 to S25 are repeated.

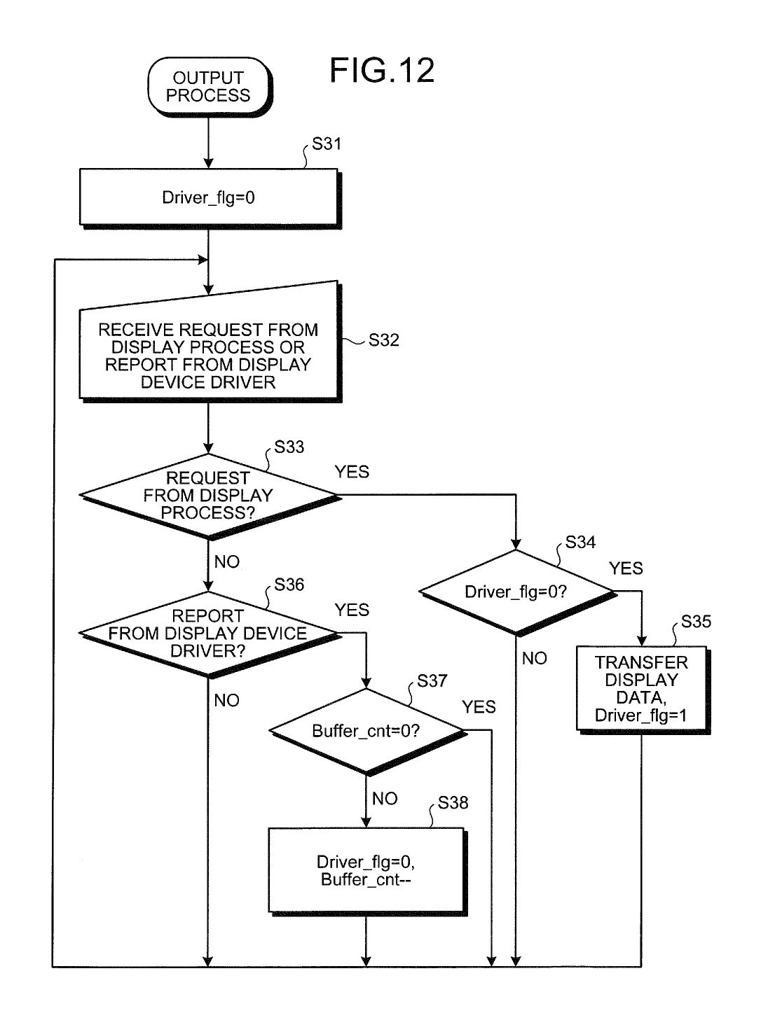

FIG. 12 is a flowchart of an output process by the electronic device of the second embodiment. The output process is executed by the display control processing unit 2.

As depicted in FIG. 12, when the electronic device 1 starts the output process, the value of Driver_flg is reset to 0 (step S31). Subsequently, the display control processing unit 34 receives a request from the above display process or a report from the display device driver 35 (step S32).

If the display control processing unit 34 has received a request from the display process (step S33: YES) and the value of Driver_flg is 0 (step S34: YES), the display control processing unit 34 transfers display data to the display device driver 35 and sets the value of Driver_flg to 1 (step S35). This means that because the previous process at the display device driver 35 is over, the display control processing unit 34 requests the display device driver 35 to output display data. The process flow then returns to step S32, from which steps S32 to S38 are repeated.

If the display control processing unit 34 has received a request from the display process (step S33: YES) and the value of Driver_flg is not 0 (step S34: NO), it means that the previous process at the display device driver 35 is not over. The process flow thus returns to step S32, from which steps S32 to S38 are repeated. If the display control processing unit 34 has received not a request from the display process (step S33: NO) but a report from the display device driver 35 (step S36: YES) and the value of Buffer_cnt is 0 (step S37: YES), the process flow returns to step S32, from which steps S32 to S38 are repeated.

If the value of Buffer_cnt is not 0 (step S37: NO), the value of Driver_flg is set to 0, and the value of Bhffer_cnt is decreased by 1 (step S38). The process flow then returns to step S32, from which steps S32 to S38 are repeated. If the display control processing unit 34 has received neither a request from the display process (step S33: NO) nor a report from the display device driver 35 (step S36: NO), the process flow returns to step S32, from which steps S32 to S38 are repeated.

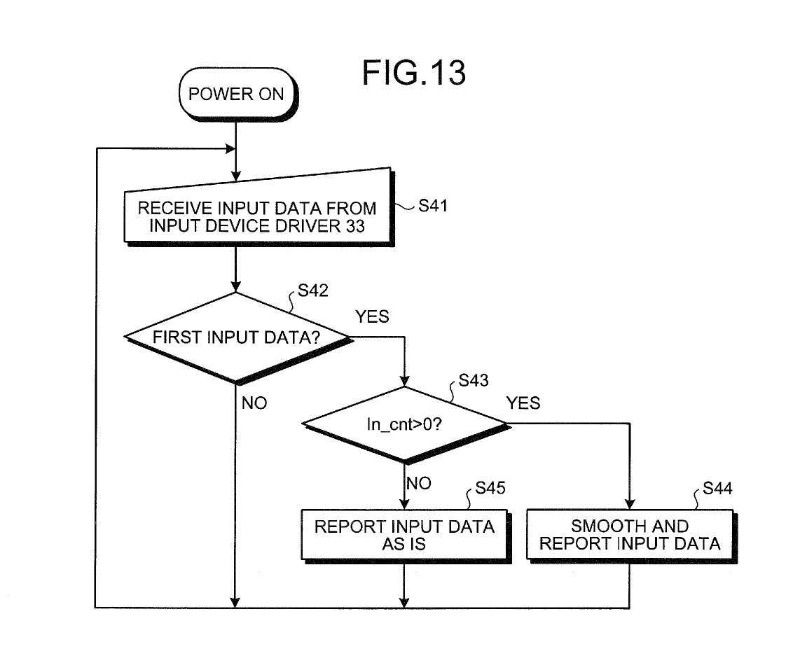

FIG. 13 is a flowchart of an input process by the electronic device of the second embodiment. The input process is executed by the input control processing unit 2.

As depicted in FIG. 13, the power supply of the electronic device 1 is turned on and the input control processing unit 2 receives input data from the input device driver 33 (step S41). If the input data is first input data (step S42: YES) and the value of In_cnt is greater than 0 (step S43: YES), the input control processing unit 2 smoothes the first input data by the moving average method, etc., to acquire second input data.

This means that because the quantity of data to be culled at the input process is not 0, the input control processing unit 2 executes the culling process and the input control processing unit 2 reports the second input data to the application software 32 (step S44). The process flow then returns to step S41, from which steps S41 to S45 are repeated.

If the input data from the input device driver 33 is the first input data (step S42: YES) and the value of In_cnt is not greater than 0 (step S43: NO), the input control processing unit 2 reports the first input data left as is to the application software 32 (step S45). The process flow then returns to step S41, from which steps S41 to S45 are repeated. If the input data from the input device driver 33 is not the first input data (step S42: NO), the process flow then returns to step S41, from which steps S41 to S45 are repeated.

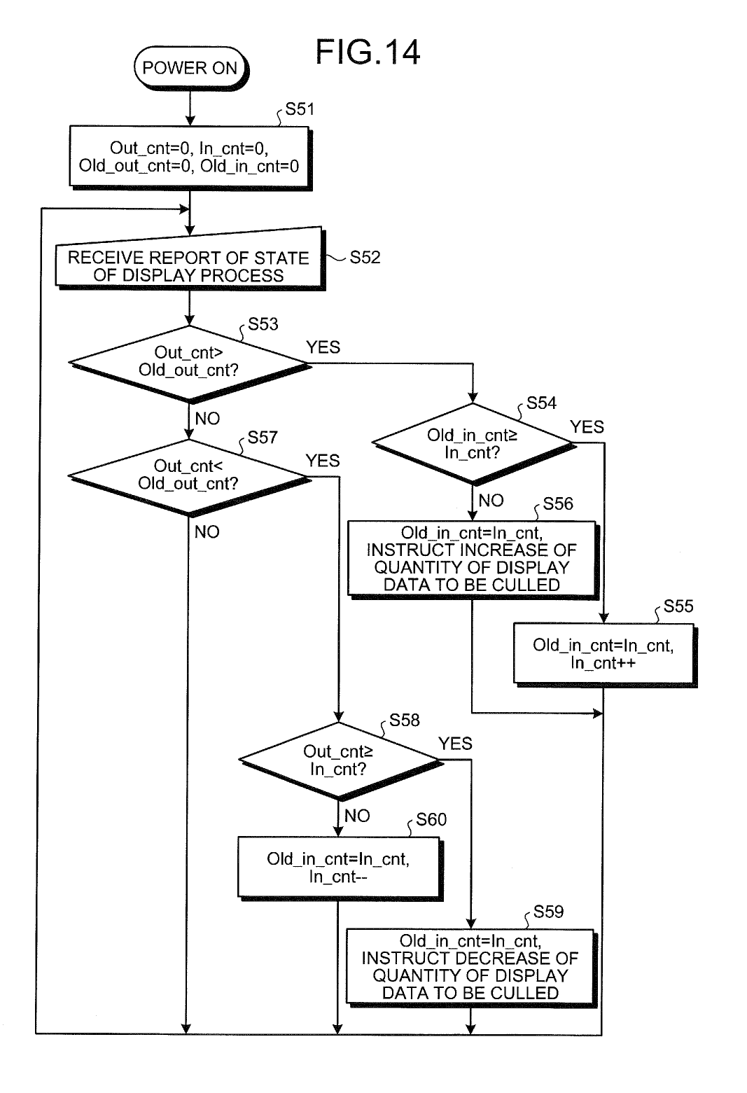

FIG. 14 is a flowchart of a congestion control process by the electronic device of the second embodiment. The congestion control process is executed by the congestion control unit 4.

As depicted in FIG. 14, when the power supply of the electronic device 1 is turned on, the values of Out_cnt, In_cnt, Old_out_cnt, and Old_in_cnt are each reset to 0 (step S51). When the congestion control unit 4 receives a report of the state of the display process from the display control processing unit 34 (step S52), if the value of Out_cnt is greater than the value of Old_out_cnt (step S53: YES), it means a level of a display delay is rising.

In this case, if the value of Old_in_cnt is greater than or equal to the value of In_cnt (step S54: YES), it means that the quantity of data to be culled at the input process is not increasing. The congestion control unit 4, therefore, updates the value of Old_in_cnt to the current value of In_cnt and increases the value of In_cnt by 1 (step S55). As a result, the quantity of first input data to be culled at the input process is increased. The process flow then returns to step S52, from which steps S52 to S60 are repeated.

If the value of Out_cnt is greater than the value of Old_out_cnt (step S53: YES) and the value of Old_in_cnt is not greater than or equal to the value of In_cnt (step S54: NO), it means that the quantity of data to be culled at the input process is increasing. The congestion control unit 4, therefore, updates the value of Old_in_cnt to the current value of In_cnt, and instructs the display control processing unit 34 to increase the quantity of display data to be culled at the display process (step S56). As a result, the quantity of display data to be culled at the display process is increased. The process flow then returns to step S52, from which steps S52 to S60 are repeated.

When display delay occurs during the processes at steps S54 to S56, the culling at the input process is performed preferentially. If the level of display delay continues to increase despite an increase in the quantity of data to be culled at the input process, the quantity of data to be culled at the display process is increased.

When the congestion control unit 4 receives a report of a state of the display process (step S52), if the value of Out_cnt is not greater than the value of Old_out_cnt (step S53: NO), it means that the level of the display delay is not rising. In this case, if the value of Out_cnt is less than the value of Old_out_cnt (step S57: YES), it means that the level of the display delay is decreasing.

Then, if the value of Out_cnt is greater than or equal to the value of In_cnt (step S58: YES), it means that the quantity of data to be culled at the display process is greater than or equal to the quantity of data to be culled at the input process. The congestion control unit 4, therefore, updates the value of Old_in_cnt to the current value of In_cnt, and instructs the display control processing unit 34 to decrease the quantity of display data to be culled (step S59). As a result, the quantity of display data to be culled at the display process is decreased. The process flow then returns to step S52, from which steps S52 to S60 are repeated.

When the level of display delay is decreasing (step S57: YES), if the value of Out_cnt is not greater than or equal to the value of In_cnt (step S58: NO), it means that the quantity of data to be culled at the input process is greater than the quantity of data to be culled at the display process. The congestion control unit 4, therefore, updates the value of Old_in_cnt to the current value of In_cnt, and decreases the value of In_cnt by 1 (step S60). As a result, the quantity of first input data to be culled at the input process is decreased. The process flow then returns to step S52, from which steps S52 to S60 are repeated.

As the display delay is reduced through the process of steps S58 to S60, the quantity of data to be culled at the display process is decreased first. When the level of the display delay continues to decrease irrespective of a decrease in the quantity of data to be culled at the display process, the quantity of data to be culled at the input process is then decreased.

When the level of the display delay is neither rising (step S53: NO) nor decreasing (step S57: NO), the process flow returns to step S52, from which steps S52 to S60 are repeated. Immediately after turning on of the power supply of the electronic device 1, because the values of Out_cnt and Old_out_cnt are 0 at this moment, NO results at step S57, after which the process flow returns to step S52.

According to the second embodiment, when delay in output relative to input occurs, data culling at the input process is performed first preferentially. If the delay is not remedied by this data culling, data culling at the display process is then performed. As the delay in output relative to input is reduced, the quantity of data to be culled at the display process is decreased first, and then the quantity of data to be culled at the input process is decreased. This prevents the loss of continuity of display and processing before and after data culling at the input process and display process.

Performing only the data culling at the input process results in an increase in the quantity of data to be culled at the input process, which raises a concern that data input through independent, meaningful contact, such as tapping defined as an operational action on a smart phone, may be culled. According to the second embodiment, data culling at the input process and data culling at the display process are performed in a combined form. This prevents culling of data input through independent, meaningful contact.

The equation for calculating a moving average, the quantity of display buffers, and the method of culling display data in the smoothing culling process are not limited to the examples described above but may be modified suitably.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An electronic device comprising:
an input control processing unit that culls first input data by generating second input data from the first input data;
an output control processing unit that culls output data; and
a congestion control unit that instructs the input control processing unit to increase a quantity of the first input data to be culled, when delay in output relative to input is increasing, and instructs the output control processing unit to increase a quantity of the output data to be culled when the delay in output relative to input continues to increase despite the increase in the quantity of the first input data to be culled.

2. The electronic device according to claim 1, wherein
the congestion control unit instructs the output control processing unit to decrease the quantity of the output data to be culled, when the delay in output relative to input is decreasing and instructs the input control processing unit to decrease the quantity of the first input data to be culled, when the delay in output relative to input continues to decrease irrespective of the decrease in the quantity of the output data to be culled.

3. The electronic device according to claim 1, wherein
the input control processing unit generates the second input data by calculating a moving average of the first input data of a quantity corresponding to the quantity of the first input data to be culled.

4. The electronic device according to claim 1, wherein
the output control processing unit discards from among the second input data to be processed, the second input data of a quantity corresponding to the quantity of the output data to be culled.

5. A control method comprising:
increasing a quantity of first input data to be culled, when delay in output relative input is increasing;
culling the first input data by generating second input data from the first input data based on the quantity of first input data to be culled;
increasing a quantity of output data to be culled when the delay in output relative to input continues to increase despite the increase in the quantity of the first input data to be culled; and
culling the output data based on the quantity of output data to be culled.

6. The control method according to claim 5, comprising:
decreasing the quantity of the output data to be culled when the delay in output relative input is decreasing;
culling the output data based on the quantity of output data to be culled;
decreasing the quantity of the first input data to be culled when the delay in output relative to input continues to decrease irrespective of the decrease in the quantity of the output data to be culled; and
culling the first input data by generating second input data from the first input data based on the quantity of the first input data to be culled.

7. The control method according to claim 5, wherein
the culling of the first input data includes generating the second input data by calculating a moving average of the first input data of a quantity corresponding to the quantity of the first input data to be culled.

8. The control method according to claim 5, wherein
the culling of the output data includes discarding from among the second input data to be processed, the second input data of a quantity corresponding to the quantity of the output data to be culled.

9. A computer-readable recording medium storing a program causing an electronic device to execute a control process comprising:
increasing a quantity of first input data to be culled, when delay in output relative input is increasing;
culling the first input data by generating second input data from the first input data based on the quantity of first input data to be culled;
increasing a quantity of output data to be culled when the delay in output relative to input continues to increase despite the increase in the quantity of the first input data to be culled; and
culling the output data based on the quantity of output data to be culled.

10. The computer-readable recording medium according to claim 9, the control process comprising:
decreasing the quantity of the output data to be culled when the delay in output relative input is decreasing;
culling the output data based on the quantity of output data to be culled;
decreasing the quantity of the first input data to be culled when the delay in output relative to input continues to decrease irrespective of the decrease in the quantity of the output data to be culled; and
culling the first input data by generating second input data from the first input data based on the quantity of the first input data to be culled.

11. The computer-readable recording medium according to claim 9, wherein
the culling of the first input data includes generating the second input data by calculating a moving average of the first input data of a quantity corresponding to the quantity of the first input data to be culled.

12. The computer-readable recording medium according to claim 9, wherein
the culling of the output data includes discarding from among the second input data to be processed, the second input data of a quantity corresponding to the quantity of the output data to be culled.
